(19) United States
(12) Patent Application Publication
(10) Pub. No.: US 2011/0228048 A1
(43) Pub. Date: Sep. 22, 2011

(54) THREE-DIMENSIONAL VIDEO DISPLAY METHOD AND SYSTEM FOR ENHANCING BLACK FRAME INSERTION EFFECT

(76) Inventors: Wen-Kang Wei, Taipei County (TW); Min-I Chen, Taipei County (TW)

(21) Appl. No.: 12/876,168

(22) Filed: Sep. 6, 2010

(30) Foreign Application Priority Data
Mar. 22, 2010 (TW) 099108324

(51) Int. Cl. H04N 13/04

(52) U.S. Cl. 348/43; 348/56

(57) ABSTRACT

In order to enhance black frame insertion effect when displaying three-dimensional images, first start to output an image frame. After completely outputting the image frame, output a black frame. After starting to output the black frame for a predetermined time and a portion of the image frame is replaced by the black frame, start to switch a left shutter and a right shutter of a pair of shutter glasses, and substantially turn off a backlight module. And after the left shutter and the right shutter are switched, substantially turn on the backlight module.

### BACKGROUND OF THE INVENTION

1. Field of the Invention

The present invention relates to a three-dimensional video display method and system thereof, and more particularly, to a three-dimensional video display method capable of enhancing a black frame insertion effect and system thereof.

2. Description of the Prior Art

In stereoscopic image display technologies, a pair of shutter glasses is usually used with a display for sequentially displaying left eye images and right eye images, so that an observer may perceive three-dimensional images. However, in existing techniques, the observer often sees ghost shadows when the stereoscopic image display transitions from a left eye image to a right eye image. More specifically, such ghost shadows are generated due to the fact that a right eye image displayed on the LCD has not entirely disappeared after a left shutter of the pair of shutter glasses is turned on, whereby the observer sees part of the right eye image in his/her left eye. Such ghost shadows also occur due to the fact that a left eye image displayed on the LCD has not disappeared after a right shutter of the pair of shutter glasses is turned on, whereby the observer sees part of the left eye image in his/her right eye.

The prior art uses a method of black frame insertion to prevent the ghost shadows. Please refer to FIG. 1. FIG. 1 is a diagram illustrating above displaying method of an LCD combined with a pair of shutter glasses. As shown in FIG. 1, the LCD displays frames 102-116 in order. The frames 102-116 include left eye image frames 102, 110, right eye image frames 106, 114, and black frames 104, 108, 112, and 116. In FIG. 1, tᵥ is a time interval required for the LCD to display a frame. The pair of shutter glasses 120 synchronizes with the frames 102-116 to switch the left shutter and the right shutter. As shown in FIG. 1, when the left eye image frame 102 is displayed, the left shutter is turned on and the right shutter is turned off, so the left eye of the user receives the left eye image frame on the LCD; when the right eye image frame 106 is displayed, the left shutter is turned off and the right shutter is turned on, so the right eye of the user receives the right eye image frame on the LCD. Likewise, when the left eye image frame 110 is displayed, the left shutter is turned on and the right shutter is turned off; when the right eye image frame 114 is displayed, the left shutter is turned off and the right shutter is turned on. Therefore, the left eye of the user receives the left eye image signals and the right eye of the user receives the right eye image signals, so that the user perceives a three-dimensional image effect through the frames 102-116 synchronized to the switching of the left shutter and the right shutter of the shutter glasses 120. However, the LCD does not display each image in its entirety at one instant, but instead uses a horizontal scan method, such that images are altered progressively. Therefore, a black frame is inserted between a right eye image frame and a left eye image frame in order to prevent the ghost shadows from being seen by the user, and vision of the user being confused. However, the prior art shown in FIG. 1 still causes the ghost shadows during switching of the shutters.

Please refer to FIG. 2. FIG. 2 is a timing diagram illustrating display order of the left eye image frames, the black frames, and the right eye image frames in coordination with the switching of the shutters of the pair of shutter glasses shown in FIG. 1. FIG. 2 illustrates the prior art shown in FIG. 1 in more detail. As shown in FIG. 2, tᵥ is a time interval required for the LCD to display a frame, and Gₜ represents a time interval for switching the shutters of the shutter glasses. In the prior art shown in FIG. 1, because it takes a time interval Gₜ to switch the shutters of the shutter glasses, the user sees the ghost shadows caused by a previous image frame. For example, if the shutter glasses are liquid crystal shutter glasses, Gₜ is about 2 ms, and tᵥ of a 240 Hz display is about 4 ms, so Gₜ equals ½tᵥ. Thus, the user sees the ghost shadows caused by half of the previous image frame displayed during the switching of the shutters of the shutter glasses.

Please refer to FIG. 2. The time interval Gₜ is about half of the time interval tᵥ. At t=0, the LCD only displays the entire black frame, as shown in a frame 202, then the LCD starts to display the left eye image frame. During a time interval from t=0 to t=tᵥ, the left eye image frame gradually replaces the black frame, and at t=tᵥ, the LCD displays the entire left eye image frame as shown in a frame 210. Then, the LCD starts to display the black frame. During a time interval from tᵥ to 2tᵥ, the black frame gradually replaces the left eye image frame, and at t=2tᵥ, the LCD displays the entire black frame, as shown in a frame 218. During display of frames 202-214, the left shutter of the shutter glasses is opened, and the right shutter of the shutter glasses is closed, so the right eye of the user cannot see the left eye image frame. During display of frames 214-218, the pair of shutter glasses 120 switches the left shutter and the right shutter, and frames 214-218 comprise portions of the left eye image frame and portions of the black frame, so the right eye of the user can see the portions of the left eye image frame. Likewise, during display of frames 230-234, the pair of shutter glasses 120 switches the left shutter and the right shutter, so the left eye of the user can see portions of the right eye image frame.

Above all, the LCD in prior art still exhibits ghost shadows during switching of the left shutter and the right shutter of the shutter glasses, which confuses the vision of the user.

### SUMMARY OF THE INVENTION

The present invention provides a method of displaying a three-dimensional image capable of enhancing black frame insertion effect. The method comprises receiving a three-dimensional video signal; adjusting the three-dimensional video signal to generate a three-dimensional image signal; generating a liquid crystal display (LCD) driving signal according to the timing of the three-dimensional image signal; displaying an image frame and a black frame in turn according to the LCD driving signal; starting switching a left shutter and a right shutter of a pair of shutter glasses after outputting the black frame for a predetermined time such that a portion of the black frame covers the image frame; turning-off a backlight module substantially at the beginning of switching the left shutter and the right shutter of the pair of shutter glasses; and turning-on the backlight module substantially after switching the left shutter and the right shutter of the pair of shutter glasses.

The present invention provides another method of displaying a three-dimensional image capable of enhancing black frame insertion effect. The method comprises receiving a three-dimensional video signal; adjusting the three-dimensional video signal to generate a three-dimensional image signal; generating a liquid crystal display (LCD) driving signal according to the timing of the three-dimensional image signal; displaying an image frame and a black frame in turn according to the LCD driving signal; synchronously controlling turning-on and turning-off of N backlight blocks of a backlight module step by step until starting to switch a left shutter and a right shutter of a pair of shutter glasses when displaying the image frame and the black frame; starting to switch the left shutter and the right shutter of the pair of shutter glasses after starting to output the black frame for a predetermined time such that a portion of the black frame covers the image frame; and turning-off all of the N backlight blocks of the backlight module substantially when the left shutter and the right shutter of the pair of shutter glasses are switched.

The present invention provides one more three-dimensional image display system capable of enhancing black frame insertion effect. The three-dimensional image display system comprises a three-dimensional video source, a backlight module, a system control board, an LCD driving module, an LCD module, a backlight driving module, and a pair of shutter glasses. The three-dimensional video source for outputting a three-dimensional video signal; the backlight module comprising a plurality of backlight blocks; the system control board for generating a three-dimensional image signal according to the three-dimensional video signal; the LCD driving module coupled to the system control board for adjusting the timing of the three-dimensional image signal to generate an LCD driving signal; the LCD module installed on a side of the backlight module and coupled to the LCD driving module for displaying an image frame and a black frame in turn according to the LCD driving signal; the backlight driving module coupled to the plurality of backlight blocks and the system control board for driving the plurality of backlight blocks in sync with outputting the black frame and the image frame; and the pair of shutter glasses comprising a left shutter and a right shutter; wherein all of the N backlight blocks of the backlight module are substantially turned-off when the left shutter and the right shutter of the pair of shutter glasses are switched.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a displaying method of an LCD combined with a pair of shutter glasses.

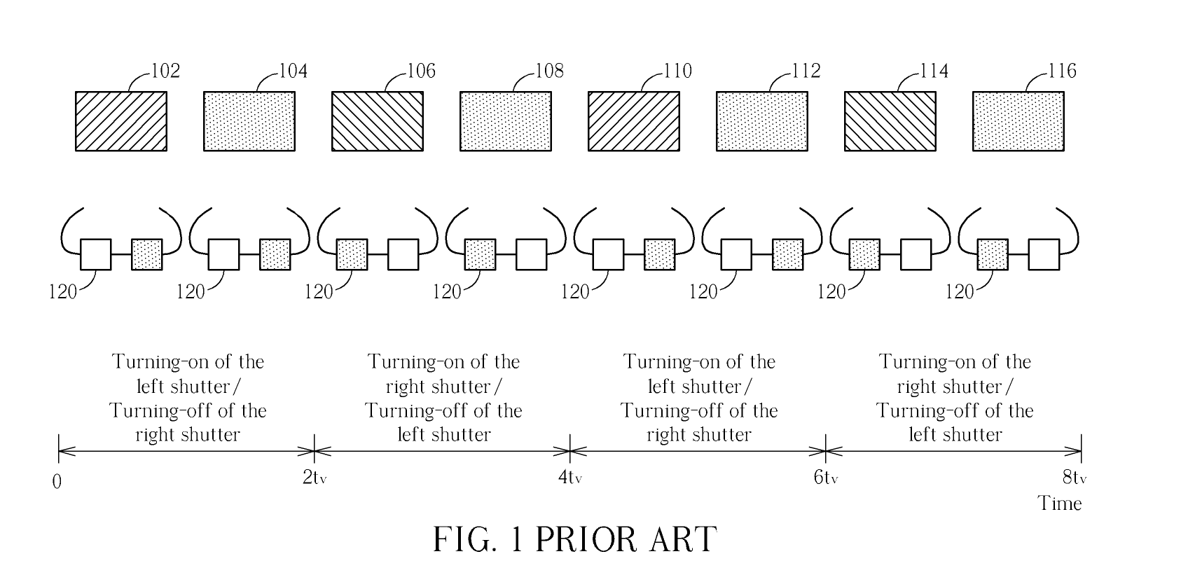

FIG. 2 is a timing diagram illustrating displaying order of left eye image frames, black frames, and right eye image frames working together with the switching of shutters of a pair of shutter glasses shown in FIG. 1.

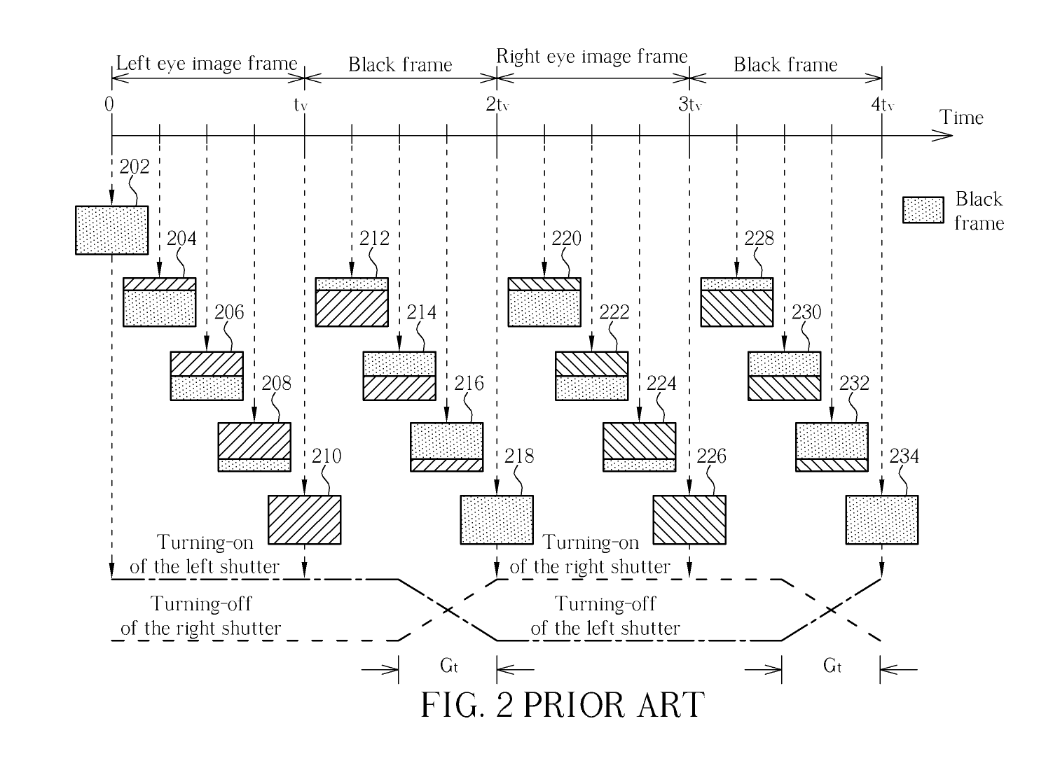

FIG. 3 is a diagram illustrating a three-dimensional image display system which can enhance the black frame insertion effect according to an embodiment of the present invention.

FIG. 4 is a diagram illustrating the system control board and the LCD driving module of the three-dimensional image display system.

FIG. 5 is a flowchart illustrating a method of displaying the three-dimensional image capable of enhancing the black frame insertion effect according to another embodiment of the present invention.

FIG. 6 is a timing diagram using the three-dimensional image display system in FIG. 3 to illustrate the method in FIG. 5.

FIG. 7 is a flowchart illustrating a method of displaying the three-dimensional image capable of enhancing the black frame insertion effect according to another embodiment of the present invention.

FIG. 8 is a timing diagram using the three-dimensional image display system in FIG. 3 to illustrate the method in FIG. 7.

### DETAILED DESCRIPTION

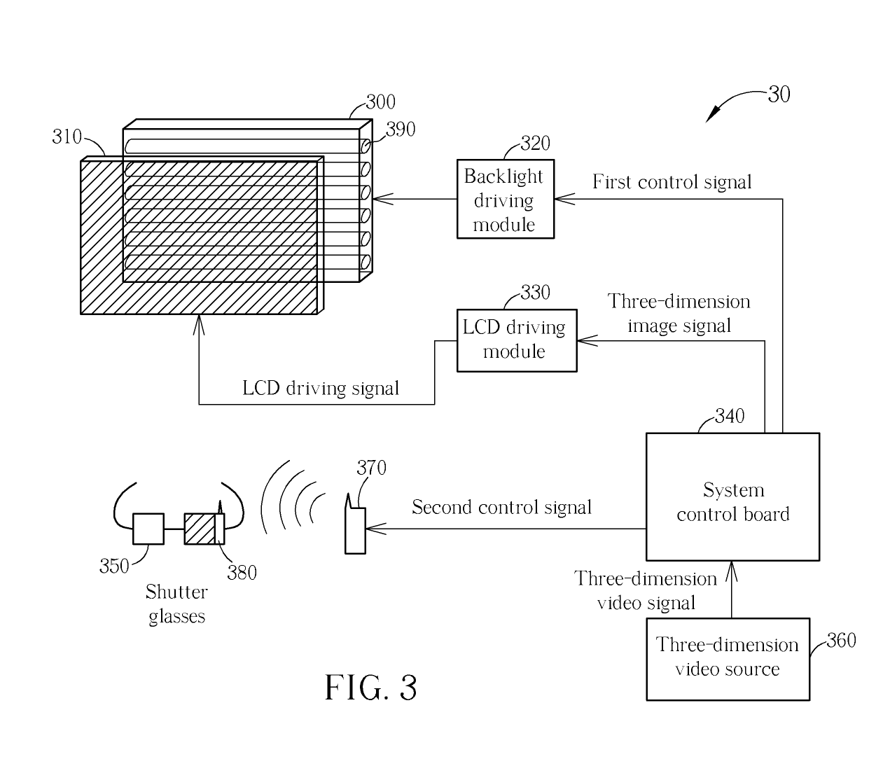

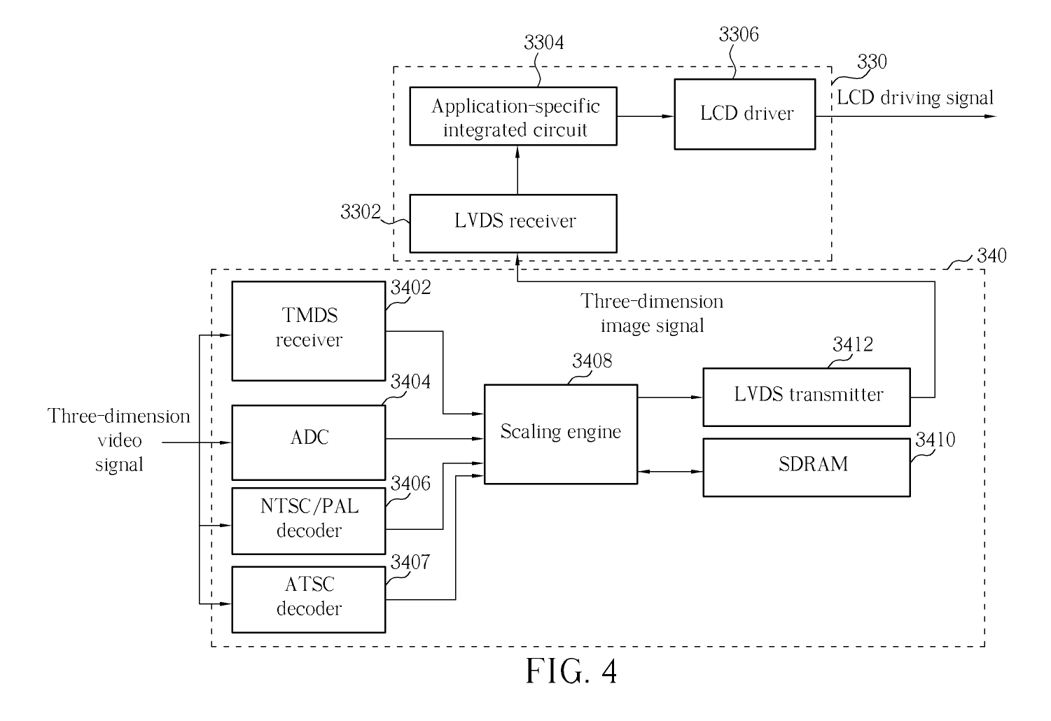

Please refer to FIG. 3 and FIG. 4. FIG. 3 is a diagram illustrating a three-dimensional image display system 30 which can enhance a black frame insertion effect according to an embodiment of the present invention. The three-dimensional image display system 30 comprises a backlight module 300, an LCD module 310, a backlight driving module 320, an LCD driving module 330, a system control board 340, a pair of shutter glasses 350, a three-dimensional video source 360, a wireless signal transmitter 370, and a wireless signal receiver 380. FIG. 4 is a diagram illustrating the system control board 340 and the LCD driving module 330 of the three-dimensional image display system 30. The system control board 340 comprises a transition minimized differential signaling (TMDS) receiver 3402, an analog-to-digital converter (ADC) 3404, a digital/analog tuner 3405, a scaling engine 3408, an synchronous dynamic random access memory (SDRAM) 3410 and a low-voltage differential signaling (LVDS) transmitter 3412. The digital/analog tuner 3405 may comprise an NTSC/PAL decoder 3406 and an ATSC decoder 3407. The LCD driving module 330 may comprise an LVDS receiver 3302, an application-specific integrated circuit (ASIC) 3304 and an LCD driver 3306.

The three-dimensional video source 360 outputs a three-dimensional video signal. The backlight module 300 comprises a plurality of backlight blocks 390. The backlight module 300 partially controls the plurality of backlight blocks 390. The backlight module 300 may be a backlight module with a plurality of light-emitting diodes (LEDs) or a backlight module with a plurality of cold cathode fluorescent lamps (CCFLs), but the present invention is not limited to the above backlight modules. The system control board 340 is coupled to the backlight driving module 320 and the LCD driving module 330 for outputting a first control signal to the backlight driving module 320 and a second control signal to the wireless signal transmitter 370.

When the three-dimensional video source 360 transmits the three-dimensional video signal to the system control board 340, the TMDS receiver 3402 in the system control board 340 receives digital signals of the three-dimensional video signal and transmits audio signals, video signals, and other auxiliary data of the three-dimensional video signal; the ADC 3404 receives RGB signals of the three-dimensional video signal. The scaling engine 3408 is coupled to the TMDS receiver 3402, the ADC 3404, the NTSC/PAL decoder 3406 and the ATSC decoder 3407 for adjusting the three-dimensional video signal, which may be adjusted for color, luminance, resolution and/or contrast by the TMDS receiver 3402, the ADC 3404, the NTSC/PAL decoder 3406 and the ATSC decoder 3407. The SDRAM 3410 is coupled to the scaling engine 3408 for storing the three-dimensional video signal adjusted by the scaling engine 3408. The LVDS transmitter 3412 is coupled to the scaling engine 3408 and the LCD driving module 330 for transforming the three-dimensional video signal adjusted by the scaling engine 3408 into the three-dimensional image signal, and outputting the three-dimensional image signal to the LCD driving module 330. In addition, the system control board 340 may also have a function of displaying an on-screen display (OSD), which lets a user adjust display range, luminance and other features of the LCD module 310.

The LCD driving module 330 is coupled to the LCD module 310 and the system control board 340. The LVDS receiver 3302 is coupled to the LVDS transmitter 3412 for receiving the three-dimensional image signal. The application-specific integrated circuit 3304 is coupled to the LVDS receiver 3302 for adjusting timing of the three-dimensional image signal to generate a time-adjusted three-dimensional image signal. The LCD driver 3306 is coupled to the application-specific integrated circuit 3304 for generating the LCD driving signal according to the time-adjusted three-dimensional image signal, and outputting the LCD driving signal to the LCD module 310. The LCD module 310 may generate an image frame according to the LCD driving signal from the LCD driving module 330. The backlight driving module 320 is coupled to the plurality of backlight blocks 390 and the system control board 340 for driving the plurality of backlight blocks 390 step by step according to the first control signal. As shown in FIG. 3, the shutter glasses 350 receive the second control signal from the wireless signal transmitter 370 through the wireless signal receiver 380, where the wireless signal transmitter 370 is coupled to the system control board 340. And, the shutter glasses 350 control turning on and turning off of a left shutter and a right shutter according to the second control signal. Wireless transmission between the wireless signal transmitter 370 and the wireless signal receiver 380 may be through Bluetooth, Wi-Fi, IR, or other wireless transmission mediums. In addition, the three-dimensional video source 360 may be a computer, a DVD player, or other video sources outputting three-dimensional video signals.

Regarding substantial turning on and turning off of the backlight module 300 and the backlight blocks 390 mentioned in the embodiments, substantial turning-off may comprise reducing luminance of the backlight blocks 390 (that is, dimming the luminance of the backlight blocks 390 from bright to dark) and/or turning off the backlight blocks 390 completely; substantial turning on may comprise boosting the luminance of the backlight blocks 390 (that is, tuning the luminance of the backlight blocks 390 from dark to bright) and/or fully turning on the backlight blocks 390. For example, the backlight module 300 may be the backlight module comprising a plurality of CCFLs, and the system control board 340 may transmit one or more control signals, such as Pulse Width Modulation (PWM) signals, for controlling the luminance of the backlight blocks 390 or substantially turning on/off the backlight blocks 390. In addition, the backlight module 300 may also be the backlight module comprising a plurality of LEDs, and the system control board 340 may transmit one or more control signals for controlling the luminance of the backlight blocks 390 or substantially turning on/off the backlight blocks 390.

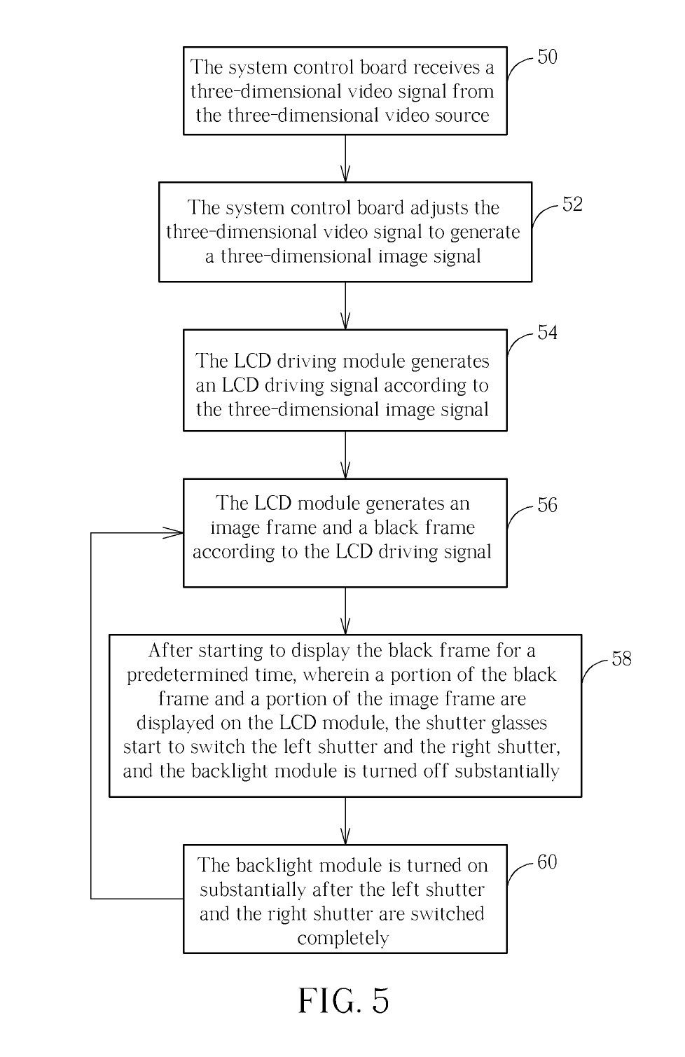

FIG. 5 is a flowchart illustrating a method of displaying the three-dimensional image capable of enhancing the black frame insertion effect according to another embodiment of the present invention. The method in FIG. 5 is illustrated with the three-dimensional image display system 30 in FIG. 3. Detailed steps are as follows:

Step 50: The system control board 340 receives a three-dimensional video signal from the three-dimensional video source 360.

Step 52: The system control board 340 adjusts the three-dimensional video signal to generate a three-dimensional image signal.

Step 54: The LCD driving module 330 generates an LCD driving signal according to the three-dimensional image signal.

Step 56: The LCD module 310 generates an image frame and a black frame according to the LCD driving signal.

Step 58: After starting to display the black frame for a predetermined time, wherein a portion of the black frame and a portion of the image frame are displayed on the LCD module 310, the shutter glasses 350 start to switch the left shutter and the right shutter, and the backlight module 300 is turned off substantially.

Step 60: The backlight module 300 is turned on substantially after the left shutter and the right shutter are switched completely; go to Step 56.

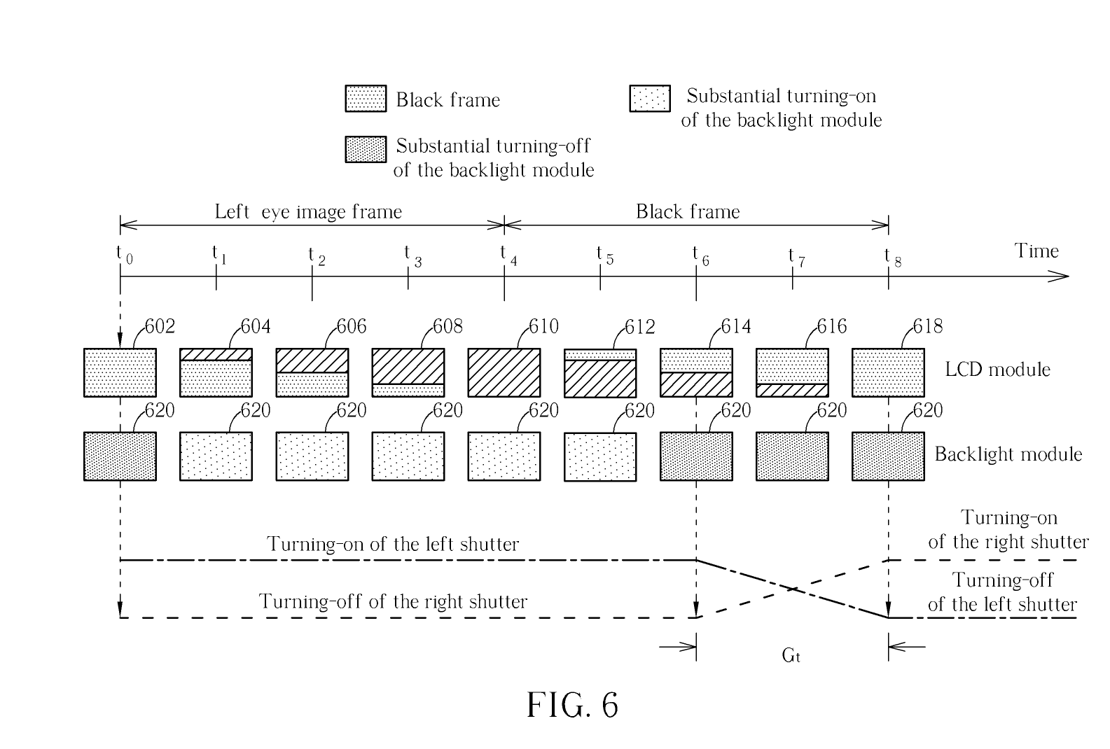

FIG. 6 is a timing diagram using the three-dimensional image display system 30 in FIG. 3 to illustrate the method in FIG. 5. As shown in FIG. 5, at t=t₀, the left shutter of the shutter glasses 350 is turned on, the right shutter of the shutter glasses 350 is turned off, and the backlight module 300 is turned on substantially. Light source in the backlight module 300 may be a plurality of LEDs or a plurality of CCFLs, but the present invention is not limited to the above light source. Meanwhile, the LCD module 310 starts to display the left eye image frame. Over a time interval t₀-t₄, the left eye image frame gradually covers the black frame as shown in frames 602-610 until the left eye image frame has covered the black frame completely and the LCD module 310 starts to display the black frame again at t=t₄. At t=t₅, the LCD module 310 has displayed a portion of the black frame on its upper portion as shown in a frame 612. Likewise, at t=t₆, the black frame displayed by the LCD module 310 further covers the left eye image frame. At the same time, that is the predetermined time after starting to display the black frame, the shutter glasses 350 start to switch the left shutter and the right shutter and the backlight driving module 320 substantially turns off the backlight module 300 according to the first control signal from the system control board 340. At t=t₈, the shutter glasses 350 have turned on the right shutter and turned off the left shutter, and the backlight driving module 320 substantially turns on the backlight module 300 according to the first control signal from the system control board 340.

Therefore, during switching of the left shutter and the right shutter of the shutter glasses 350, because the backlight module 300 is turned off substantially, the ghost shadows of the image frame may not interfere with the vision of the user. As shown in FIG. 6, at t=t₈, the black frame has completely covered the left eye image frame as shown in a frame 618, and the shutter glasses 350 completely switch the left shutter and the right shutter, but the present invention is not limited to the above switching time of the shutter glasses 350. That is to say, switching of the shutter glasses 350 may be completed before or after time t₈. Any substantial turning off of the backlight module 300 during switching of the shutter glasses 350 falls within the scope of the present invention.

In FIG. 6, the backlight module 300 is turned off substantially when the shutter glasses 350 start to switch the left shutter and the right shutter; the backlight module 300 is turned on substantially when the left shutter and the right shutter are switched completely.

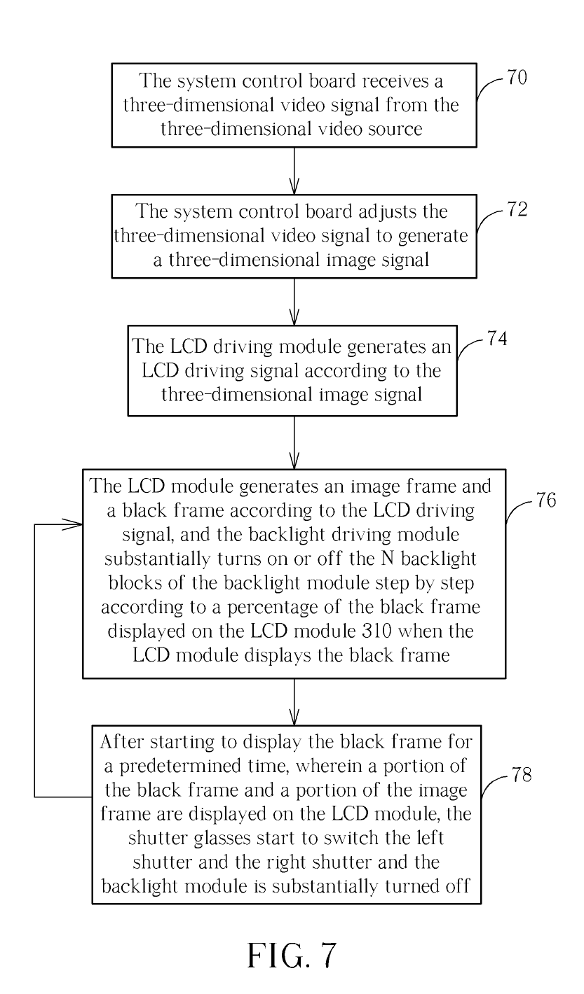

FIG. 7 is a flowchart illustrating a method of displaying the three-dimensional image capable of enhancing the black frame insertion effect according to another embodiment of the present invention. The method in FIG. 7 is illustrated with the three-dimensional image display system 30 in FIG. 3. Detailed steps are as follows:

Step 70: The system control board 340 receives a three-dimensional video signal from the three-dimensional video source 360.

Step 72: The system control board 340 adjusts the three-dimensional video signal to generate a three-dimensional image signal.

Step 74: The LCD driving module 330 generates an LCD driving signal according to the three-dimensional image signal.

Step 76: The LCD module 310 generates an image frame and a black frame according to the LCD driving signal, and the backlight driving module 320 substantially turns on or off the N backlight blocks 390 of the backlight module 300 step by step according to a percentage of the black frame displayed on the LCD module 310 when the LCD module 310 displays the black frame.

Step 78: After starting to display the black frame for a predetermined time, wherein a portion of the black frame and a portion of the image frame are displayed on the LCD module 310, the shutter glasses 350 start to switch the left shutter and the right shutter and the backlight module 300 is substantially turned off; go to Step 76.

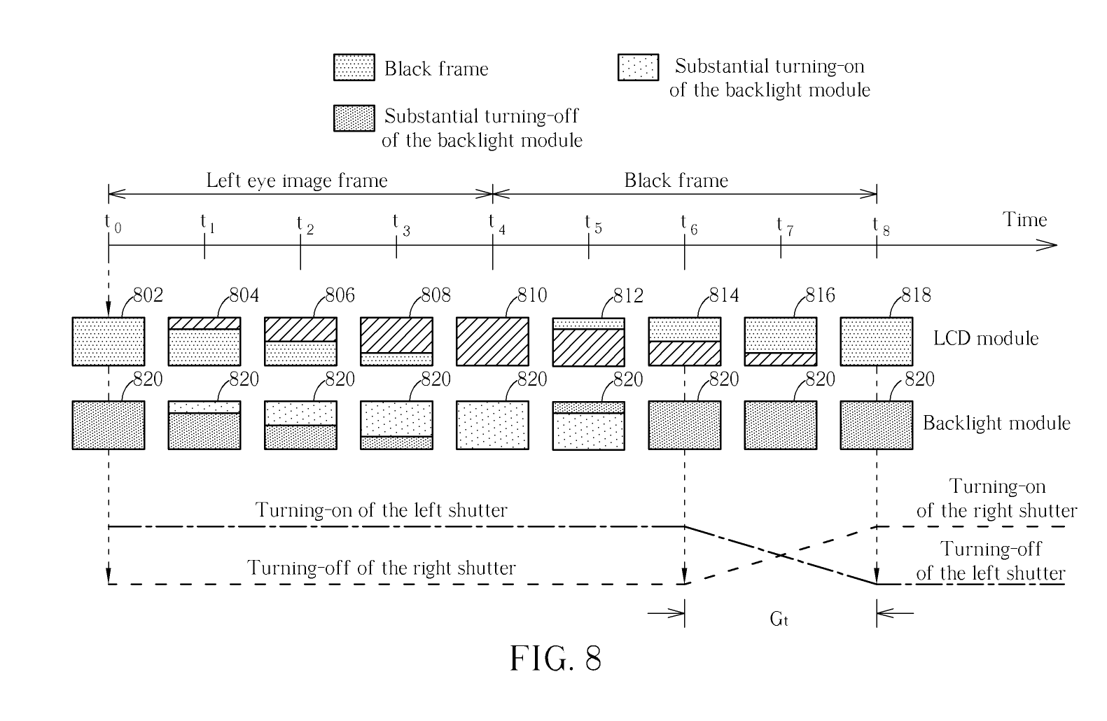

FIG. 8 is a timing diagram using the three-dimensional image display system 30 in FIG. 3 to illustrate the method in FIG. 7. As shown in FIG. 8, the backlight module 300 comprises four backlight blocks 390, but the present invention is not limited to the four backlight blocks 390. In the embodiment of FIG. 7, the backlight module 300 may be a backlight module comprising a plurality of light-emitting diodes (LEDs) or a backlight module comprising a plurality of cold cathode fluorescent lamps (CCFLs), but the present invention is not limited to the above backlight modules. Backlight modules capable of partially controlling the plurality of backlight blocks in it to enhance black frame insertion effect fall within the scope of the present invention.

At t=t₀, the left shutter of the shutter glasses 350 is turned on, the right shutter of the shutter glasses 350 is turned off, and all of the four backlight blocks 390 of the backlight module 300 are turned off substantially. Meanwhile, the LCD module 310 starts to display the three-dimensional image signal corresponding to the left eye image. At t=t₁, the LCD module 310 has displayed about ¼ of the left eye image frame as shown in frame 804, and the backlight driving module 320 substantially turns on a backlight block 390, that is a top backlight block 390 of the four backlight blocks 390, of the four backlight blocks 390 corresponding to the left eye image frame. Over a time interval from t₀ to t₃, the left eye image frame gradually covers the black image as shown in frames 802-808, so the backlight driving module 320 substantially step by step turns on the upper three backlight blocks 390 of the four backlight blocks 390 corresponding to the left eye image frame. At t=t₄, the entire left eye image frame is displayed on the LCD module 310, and the backlight driving module 320 substantially turns on all of the four backlight blocks 390 of the backlight module 300. Then, the LCD module 310 starts to display the black frame. At t=t₅, the LCD module 310 has displayed about ¼ of the black frame as shown in frame 812, and the backlight driving module 320 turns off the top backlight block 390, which corresponds to the black frame, of the four backlight blocks 390. At t=t₆, the black frame further covers the left eye image frame. At the same time, that is the predetermined time after starting to display the black frame, the shutter glasses 350 start to switch the left shutter and the right shutter, and the backlight driving module 320 substantially turns off the backlight module 300 until t=t₈. At t=t₈, when the right shutter of the shutter glasses 350 is completely turned on and the left shutter of the shutter glasses 350 is completely turned off, the backlight driving module 320 controls the four backlight blocks 390 of the backlight module 300 again according to the same timing.

Therefore, during switching of the left shutter and the right shutter of the shutter glasses 350, because the backlight module 300 is turned off substantially, the ghost shadows of the image frame do not interfere with the vision of the user. As shown in FIG. 8, at t=t₈, the black frame has completely covered the left eye image frame as shown in a frame 818, and the shutter glasses 350 completely switch the left shutter and the right shutter, but the present invention is not limited to the above switching time of the shutter glasses 350. Switching of the shutter glasses 350 may be completed before or after time t₈. Any substantial turning off of the backlight module 300 during switching of the shutter glasses 350 falls within the scope of the present invention. Moreover, in the embodiment of FIG. 7, the backlight driving module 320 further substantially turns off the backlight blocks 390 according to a percentage of the black frame displayed on the LCD module 310, so that the embodiment of FIG. 7 can further enhance the three-dimensional image effect.

To sum up, the present invention substantially turns off all of the backlight blocks of the backlight module during switching of shutters of the shutter glasses, so the present invention can achieve a good black frame insertion effect to overcome the ghost shadows of the prior art. In addition, the present invention substantially turns off the backlight blocks, which correspond to the black frame, of the backlight module during non-switching of shutters of the shutter glasses, so that the backlight module 300 can achieve a good saving power effect.

Those skilled in the art will readily observe that numerous modifications and alterations of the device and method may be made while retaining the teachings of the invention.

What is claimed is:

1. A method of displaying a three-dimensional image capable of enhancing black frame insertion effect, the method comprising:
receiving a three-dimensional video signal;
adjusting the three-dimensional video signal to generate a three-dimensional image signal;
generating a liquid crystal display (LCD) driving signal according to the three-dimensional image signal;
displaying an image frame and a black frame in turn according to the LCD driving signal; and
turning off a backlight module substantially when a left shutter and a right shutter of a pair of shutter glasses are switched.

2. The method of claim 1, further comprising starting to switch the left shutter and the right shutter of the pair of shutter glasses for a predetermined time after starting to display the black frame.

3. The method of claim 1, further comprising turning on the backlight module substantially after the left shutter and the right shutter are switched completely.

4. The method of claim 3, wherein turning on the backlight module substantially after the left shutter and the right shutter are switched completely comprises turning on the backlight module substantially after the entire black frame has been displayed.

5. The method of claim 1, wherein adjusting the three-dimensional video signal to generate the three-dimensional image signal comprises performing image processing on the three-dimensional video signal to generate the three-dimensional image signal; wherein the image processing comprises scaling, adjusting color, adjusting luminance, adjusting resolution and/or adjusting contrast.

6. A method of displaying a three-dimensional image capable of enhancing black frame insertion effect, the method comprising:
receiving a three-dimensional video signal;
adjusting the three-dimensional video signal to generate a three-dimensional image signal;
generating a liquid crystal display (LCD) driving signal according to the three-dimensional image signal;
displaying an image frame and a black frame in turn according to the LCD driving signal;
controlling substantial turning on and turning off of N backlight blocks of a backlight module step by step until starting to switch a left shutter and a right shutter of a pair of shutter glasses when displaying the image frame and the black frame; and
turning off all of the N backlight blocks of the backlight module substantially when the left shutter and the right shutter of the pair of shutter glasses are switched;
wherein N≧2.

7. The method of claim 6, further comprising starting to switch the left shutter and the right shutter of the pair of shutter glasses for a predetermined time after starting to display the black frame and a portion of the black frame covering the image frame.

8. The method of claim 6, wherein substantial turning on of the N backlight blocks of the backlight module when displaying the image frame and the black frame comprises:
turning on k backlight blocks of the N backlight blocks substantially when k/N of the image frame is displayed; and
turning off a backlight block of the N backlight blocks substantially when 1/N of the black frame is displayed;
wherein N≧k≧1.

9. The method of claim 6, wherein adjusting the three-dimensional video signal to generate the three-dimensional image signal comprises performing image processing on the three-dimensional video signal to generate the three-dimensional image signal;
wherein the image processing comprises scaling, adjusting color, adjusting luminance, adjusting resolution and/or adjusting contrast.

10. A three-dimensional image display system capable of enhancing black frame insertion effect, the three-dimensional image display system comprising:
a three-dimensional video source for outputting a three-dimensional video signal;
a backlight module comprising a plurality of backlight blocks;
a system control board for generating a three-dimensional image signal according to the three-dimensional video signal;
an LCD driving module coupled to the system control board for adjusting the three-dimensional image signal to generate a LCD driving signal;
an LCD module installed on a side of the backlight module and coupled to the LCD driving module for displaying an image frame and a black frame in turn according to the LCD driving signal;
a backlight driving module coupled to the plurality of backlight blocks and the system control board for driving the plurality of backlight blocks; and
a pair of shutter glasses comprising a left shutter and a right shutter;
wherein all of the N backlight blocks of the backlight module are turned off substantially when the left shutter and the right shutter of the pair of shutter glasses are switched.
